(19) United States
(12) Patent Application Publication
(10) Pub. No.: US 2011/0248822 A1
(43) Pub. Date: Oct. 13, 2011

(54) SYSTEMS AND APPARATUSES AND METHODS TO ADAPTIVELY CONTROL CONTROLLABLE SYSTEMS

(75) Inventor: Tan Deniz Sarihan, Portland, OR (US)

(73) Assignee: JC IP LLC, Portland, OR (US)

(21) Appl. No.: 13/082,663

(22) Filed: Apr. 8, 2011

Related U.S. Application Data
(60) Provisional application No. 61/322,791, filed on Apr. 9, 2010.

(51) Int. Cl. G06F 7/04

(52) U.S. Cl. 340/5.81

(57) ABSTRACT

A system can include a presence apparatus, an identification apparatus, an interaction apparatus, and a controlling apparatus.

### RELATED APPLICATION DATA

The present application claims the benefit of U.S. Provisional Patent Application No. 61/322,791, titled “SYSTEMS AND APPARATUSES AND METHODS TO ADAPTIVELY CONTROL CONTROLLABLE SYSTEMS” and filed on Apr. 9, 2010, the content of which is fully incorporated by reference herein.

### FIELD

There is a system which has means of being controlled. Described systems, apparatuses and methods allows user of such a system to have a customized user experience thereby improving the usability of the system by such user.

### BACKGROUND

With the advancements in technology, most devices, or systems have means of being controlled to allow a person or another machine to change behavior of such a system to achieve an intent by such user or machine.

Initial control methods included buttons, knobs, sliders and similar means of physical means to control such systems.

Next generation control methods included touch panels, which have buttons, knobs and similar means of controls on a touch screen representation.

After touch panels, ability to change looks of such interfaces from a preset selection of user interfaces like simple user interface, advanced user interface and similar introduced.

Next advancement to preset interfaces was giving user the ability to choose presets or enable disable certain features from a settings screens, which is manual by nature or drops to a default preset setting if no action is taken by user.

Another advancement was to introduce a central management system to choose certain presets for certain user by an system administrator overseeing a plurality of systems.

### SUMMARY

This invention advances the current art by introducing adaptive control system, which adapts itself and changes how the interaction between the user and system takes place. It determines changes based on user behavior, group behavior, system behavior and networked behavior pattern exchange between users, groups, systems and predetermined patterns stored in the system based on behavior science, previous patterns and events.

Invention may be especially useful in the case of complicated systems like video conferencing, Telepresence, document camera control, TV studio camera control systems. Those systems usually have a lot of parts, systems and devices which may talk to each other and most of those require user input to perform certain functions like calling. Invention introduces automatic user interface customization and adaptively changing user interface, offering users a user interface that may fit the needs of the user, therefore reducing confusion and increase user acceptance of technology, which may result in higher return on investment in such complicated systems.

Invention described here are not limited to such applications described above and may be used in any environment that may include none or singularity or plurality of controlling systems, interaction apparatuses, which may utilize systems, apparatuses, methods described in disclosed technology in this document.

### BRIEF DESCRIPTION OF THE DRAWINGS

FIG. 1 illustrates detection of presence of people and identifying user or users.

FIG. 2 illustrates welcome screen on interaction apparatus.

FIG. 3 illustrates control screen on interaction apparatus.

FIG. 4 illustrates a first call screen on interaction apparatus when call button may be pushed.

FIG. 5 illustrates screen on interaction apparatus for second and further calls to be added to existing call or calls when call button may be pushed.

FIG. 6 illustrates call hang-up screen on interaction apparatus when hang-up button may be pushed.

FIG. 7 illustrates camera control screen without image/video display on interaction apparatus.

FIG. 8 illustrates camera control screen with image/video display on interaction apparatus.

FIG. 9 illustrates document camera screen without image/video display on interaction apparatus.

FIG. 10 illustrates document camera screen with image/video display on interaction apparatus.

FIG. 11 illustrates TV control screen on interaction apparatus.

FIG. 12 illustrates control screen of DVD receiver or something else connected to system on interaction apparatus.

FIG. 13 illustrates PC/PC Laptop/Mac control when virtual keyboard is hidden screen on interaction apparatus.

FIG. 14 illustrates PC/PC Laptop/Mac control when virtual keyboard is visible and operational screen on interaction apparatus.

FIG. 15 illustrates a flowchart of the procedure for detecting presence of people and identifying user or users.

FIG. 16 illustrates an example Control System.

FIG. 17 illustrates an example Controlling Apparatus.

FIG. 18 illustrates an example Interaction apparatus.

FIG. 19 illustrates an example User Presence Detection Apparatus.

FIG. 20 illustrates an example Person Identity Detection Apparatus.

FIG. 21 illustrates an example Interaction Apparatus Modifier Apparatus.

### DETAILED DESCRIPTION

The order of systems, apparatuses, methods, sentences, steps in this document may be presented in different ways in different implementations of the described systems, apparatuses, methods and not limited to order or the way they are described here. The screen layouts, button layouts, graphics, icons, text on screen in this document may be presented in different ways in different implementations of the described system, apparatus, methods and not limited to layouts, graphics, icons, text described or presented or drawn in figures or descriptions.

While detecting user presence, interaction apparatus and/or controlling apparatus may detect the presence of a person in the vicinity of interaction apparatus and/or controlling apparatus using the following:
Ultrasonic Motion detectors,
Cameras
Infrared sensors
Pressure sensors (if person step on an area)
Contact switches (open door, close door etc.)
Other ways of detection a person in the vicinity of controlling apparatus and/or interaction apparatus
   While activating comfort elements and/or user identification enhancement elements and enabling person identity detection, once user presence may be detected controlling apparatus and/or interaction apparatus if enabled to do so may include send commands to controlled devices which may modify the environment by having controlled thermostat device which may adjust temperature, controlled light apparatus or systems which may adjust lighting, or may cause other controlled devices which may perform actions. If enabled controlling apparatus and/or interaction apparatus may light up screen, light up indicators, play audio prompts, play video prompts, play instructions which may use interaction apparatus through interaction apparatus and/or control apparatus or audio and/or video output devices connected to interaction apparatus and/or control apparatus. Controlling apparatus and interaction apparatus, if exist, may be singularity or plurality of apparatuses.
   Interaction apparatus and controlling apparatus send command to person identity detection apparatus to identify person in the vicinity of the system.
   While identifying user, once the person identity detection apparatus may be enabled, person identity detection apparatus detects identity of the person and send information to controlling apparatus and/or interaction apparatus using one of the following:
Active or passive RFID tag
Bluetooth device he may be carrying all times (cell phone, or active device for identification)
Proximity cards
Unique PIN number to enter that belongs to just that user
Face detection, recognition and authentication
Other ways of identifying a person in the vicinity of controlling apparatus and/or interaction apparatus.
   Controlling apparatus and interaction apparatus and person identity detection apparatus, if exist, may be singularity or plurality of apparatuses.
   While getting user preferences, once person may be identified, interaction apparatus and/or control apparatus send a command and identity information of identified person to interaction apparatus modifier apparatus, which reads data from storage, and determines modifications in interaction apparatus and/or controlling apparatus based on the user identity. Interaction apparatus modifier apparatus may store data in one or more of the following storage mediums:
Magnetic Storage Hard drive
RAM
Solid state hard drive
In RFID tags
In user identification devices with memory
Other methods of central or proximity readable writable storage
Other storage
   While adjusting user interface, once the modifications are determined, interaction apparatus modifier apparatus, modifies interaction apparatus and/or controlling apparatus based on the modifications determined.
   While observing system interaction and adjust user interface adaptively, controlling apparatus and/or interaction apparatus may detect user interaction with the interaction apparatus, may identify patterns of interaction using method to detect user behavior patterns, and/or method to detect user behavior patterns method, and/or method to detect predetermined usability improvement patterns, and/or any other method and may use method to change behavior of interaction apparatus based on the patterns identified, and/or may use method to adaptively change behavior of interaction apparatus, and may change behavior of the touch panel apparatus or other apparatuses accordingly in such a way that system may adapt itself.
   While saving updated user interface, as the person may continue to use the system and system may continue to adapt itself, interaction apparatus and/or control apparatus may send a command and identity information of identified person to interaction apparatus modifier apparatus, which may write data related to modifications in interaction apparatus and/or controlling apparatus based on the user identity to data storage. Interaction apparatus modifier apparatus may store data in one or more of the following storage mediums:
Magnetic Storage Hard drive
RAM
Solid state hard drive
In RFID tags
In user identification devices with memory
Other methods of central or proximity readable writable storage
Other storage

The systems described may be used in a video conference environment in a way that system may be user friendly and user may be presented with options relevant to that person as well as endpoints relevant to that user. As users uses the system, system may adjust the screens and may change layouts which may keep simplicity and may have easier to use interface depending on user interaction of user and predetermined patterns, system also may guide the user as necessary or may guide if user pushes help or like meaning buttons.

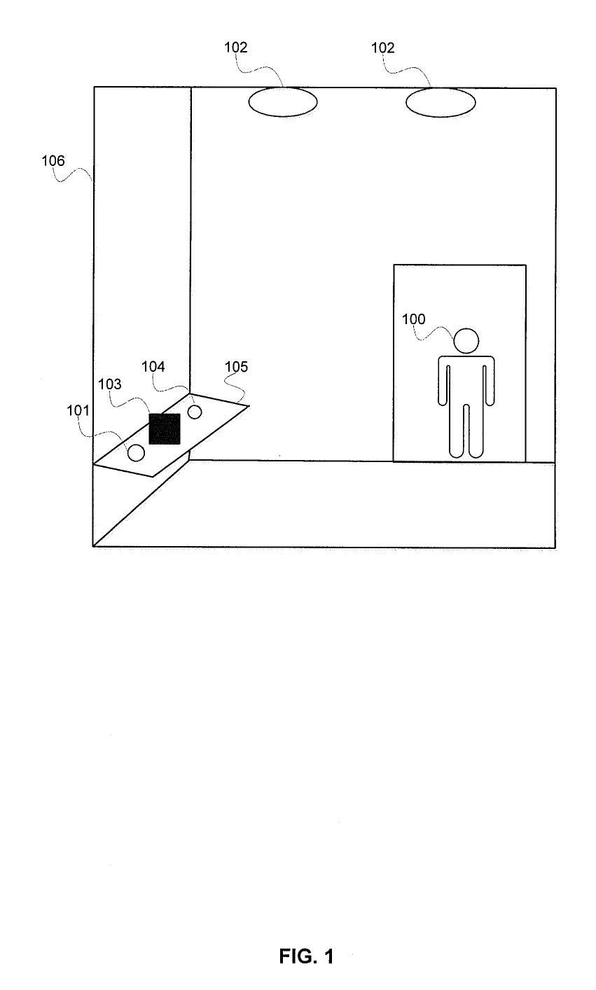

FIG. 1 illustrates detection of presence of people and identifying user or users. In FIG. 1, person 100 enters through door to room 106 where there may be presence sensor 101 that senses presence of person 100, interaction apparatus 103, and identity sensor 104 already in place on shelf or alike unit 105. Presence sensor 101 may activate the lights 102 in room 106. Identity detection and recognition time in seconds may be less than identity sensor range in feet and walk speed in feet/seconds so that there may be enough time to identify user. In certain embodiments, all entry points to area may be covered with presence sensor by using multiple sensing devices so each entry may be pointed to by one or more presence sensors or by one or more wide angle coverage sensors which may have an angle of coverage that may span all entry points to area. Person 100 that enters room 106 then interacts with interaction apparatus 103 to control devices in room 106.

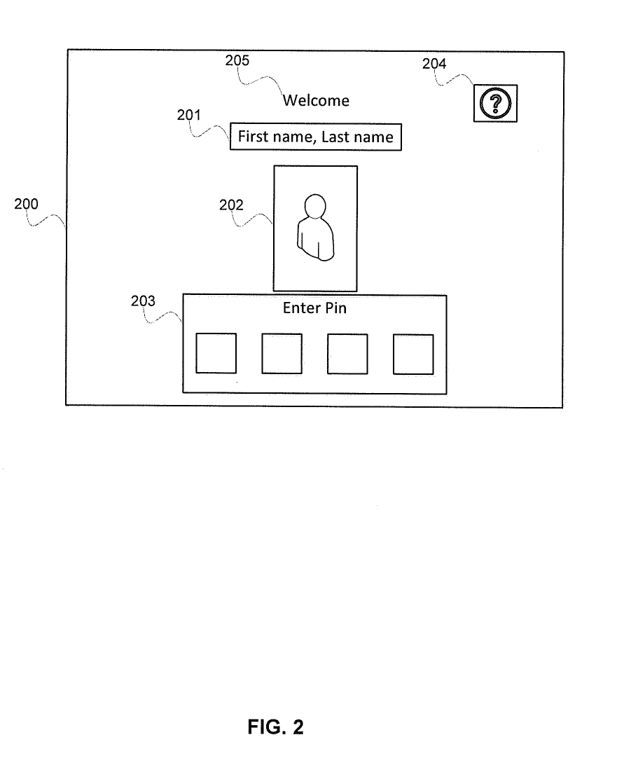

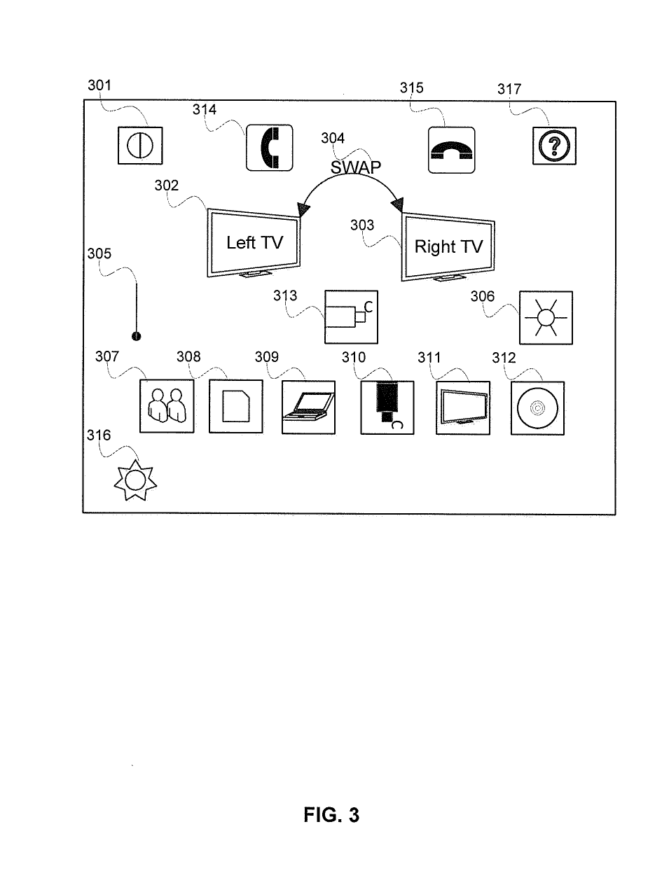

FIG. 2 illustrates welcome screen on interaction apparatus 200 that may appear once person 100 that entered room 106 is identified as user through identity sensor 104. The interaction apparatus 200 may be a touch based device such as an iPad and/or iPhone, Android, touch screen PCs or any other touch screen. FIG. 2 through FIG. 14 shows screen layouts on such a device. Different size screen layouts will be screens laid out in a way that they fit into different resolution, aspect ratio and size. Screen orientations including all four positions 0, 90, 180, 270 degrees of Portrait and Landscape orientations may be accommodated. In FIG. 2, on interaction apparatus 200, there may be welcoming message text 205, first name and last name text 201 of person 100, picture 202 of person 100, PIN number entry slot 203, and help button like meaning 204. Each identified user has a unique authentication code and personal identification number (“PIN”), which will be stored locally or on interaction apparatus (if enabled). Authentication method is chosen in settings. There are five types of users including Administrator, UserID+PIN Authenticated, UserID Only Authenticated, PIN Only Authenticated, and Public. Once identified, interaction apparatus 200 may welcome the person 205, may display name of the person 201, may show picture of the person if available 202, if enabled for it, may ask PIN for extra security 203 or may display continue button if there may be no PIN, and may have help or like meaning button 204. If there is more than one person detected, system may ask for which person is the user, or may modify interaction apparatus so that user interface may be based on the preference of both users, or perform other ways. User may enter the PIN that may be asked or may push continue button that may exist in case there may be no identification number, person may be taken to FIG. 3.

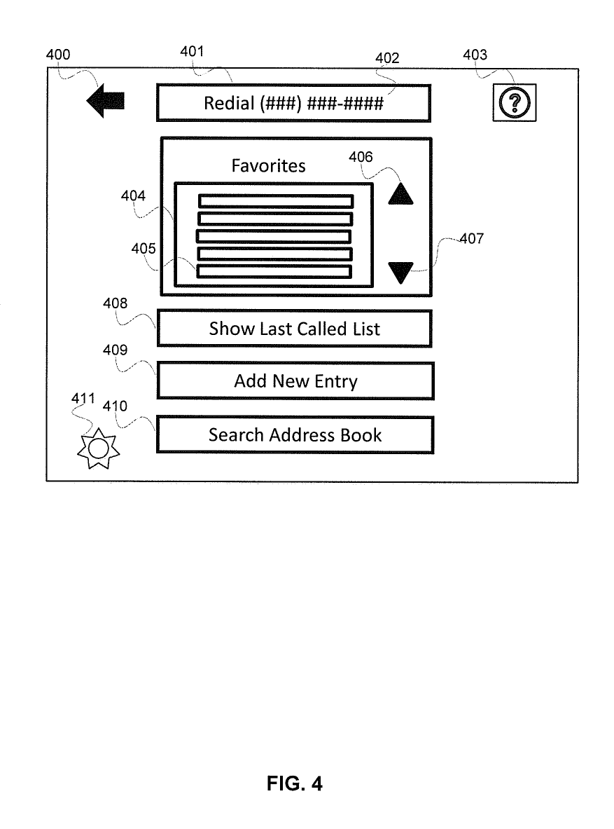

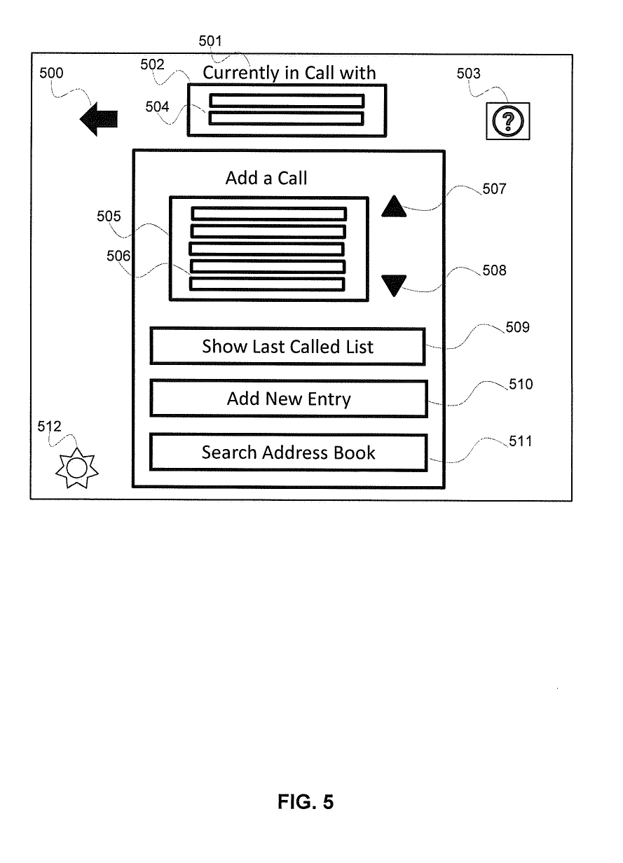

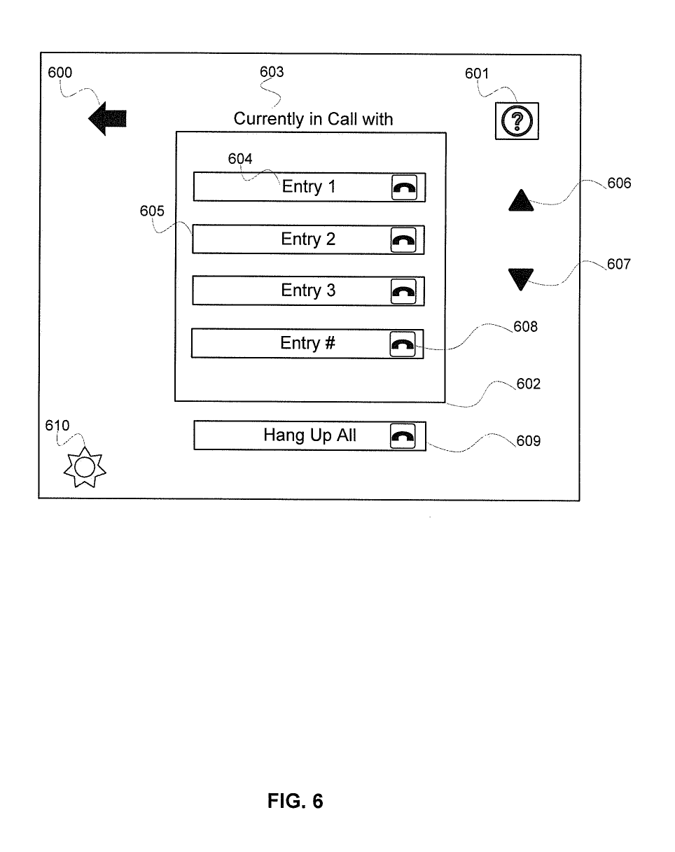

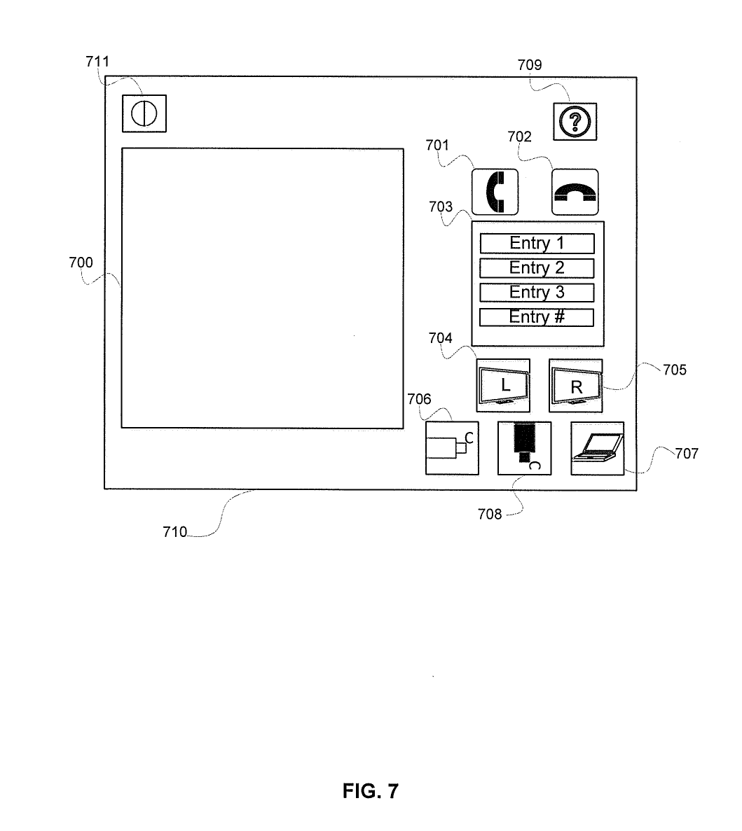

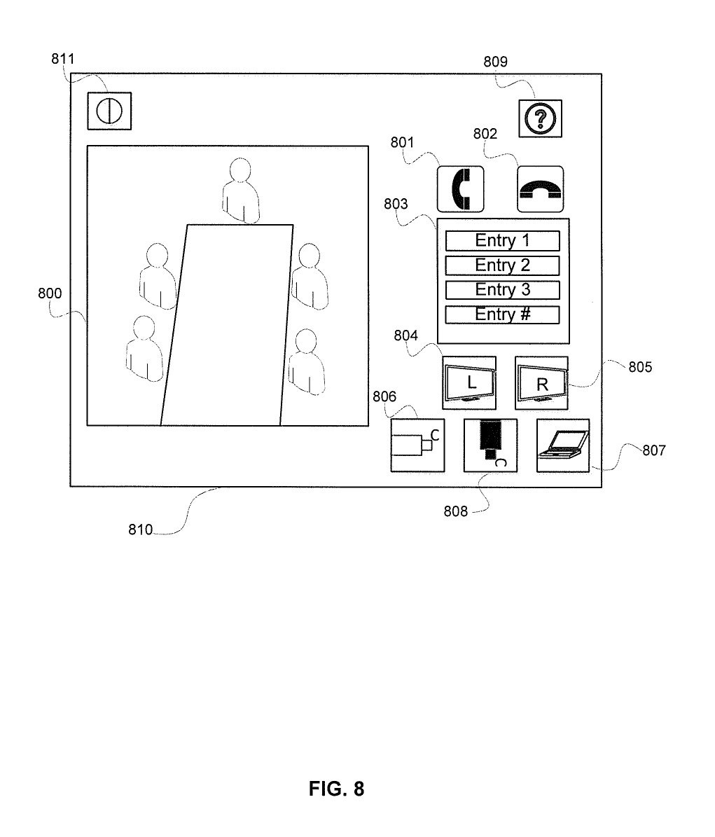

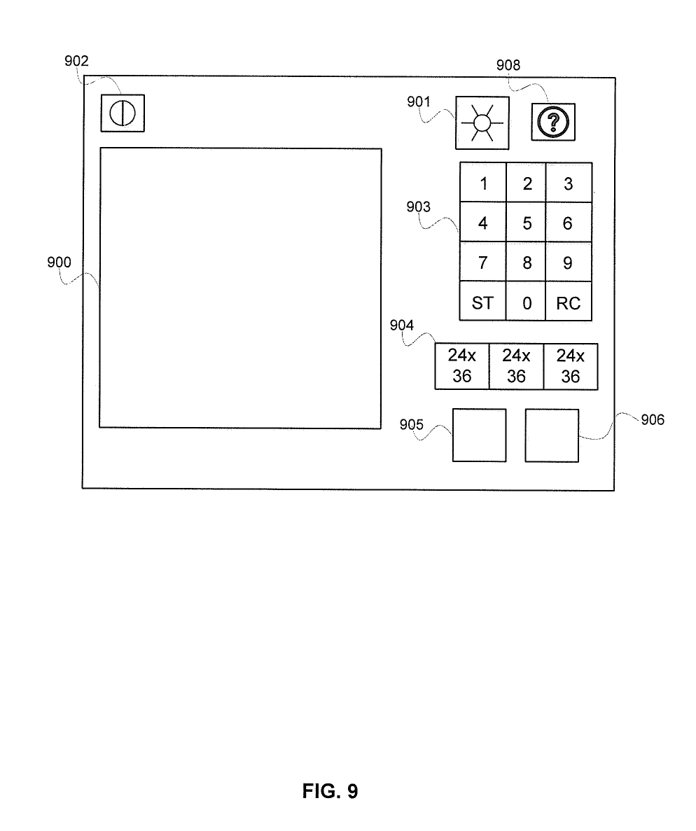

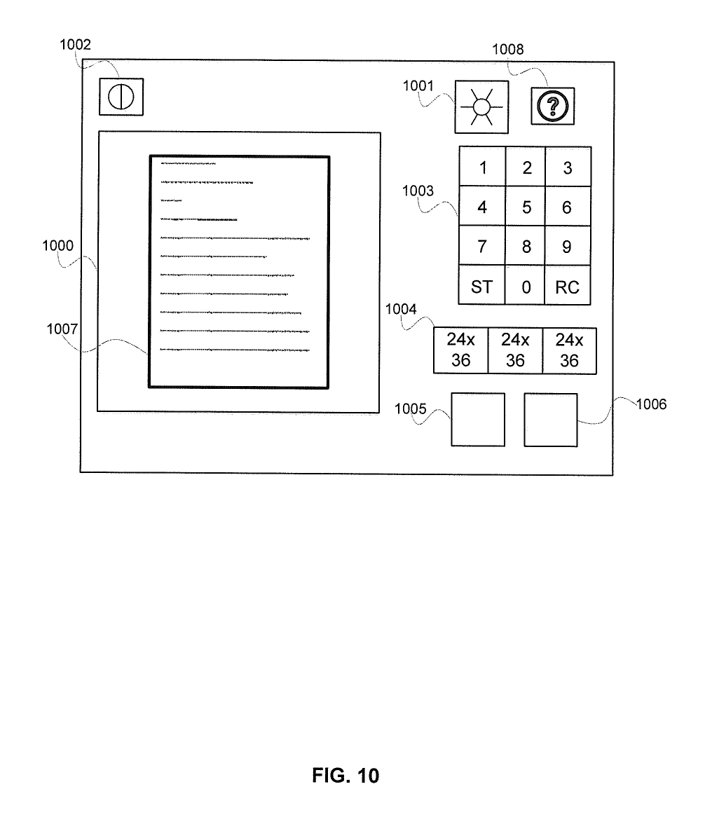

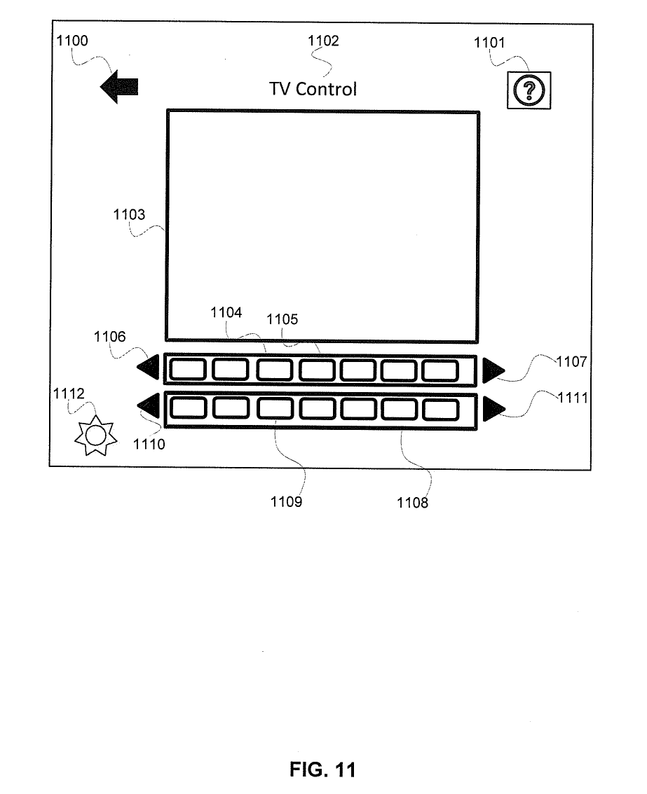

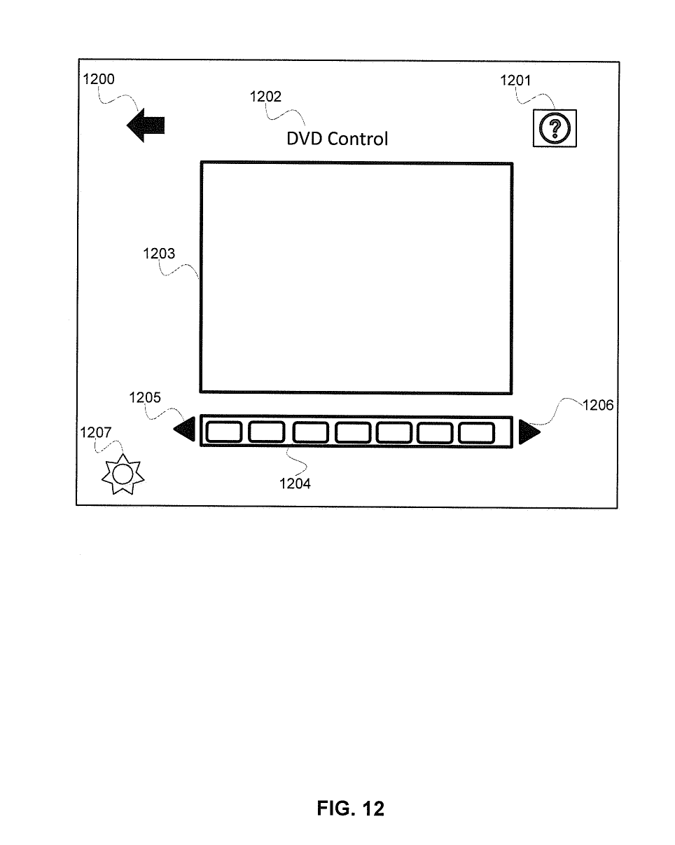

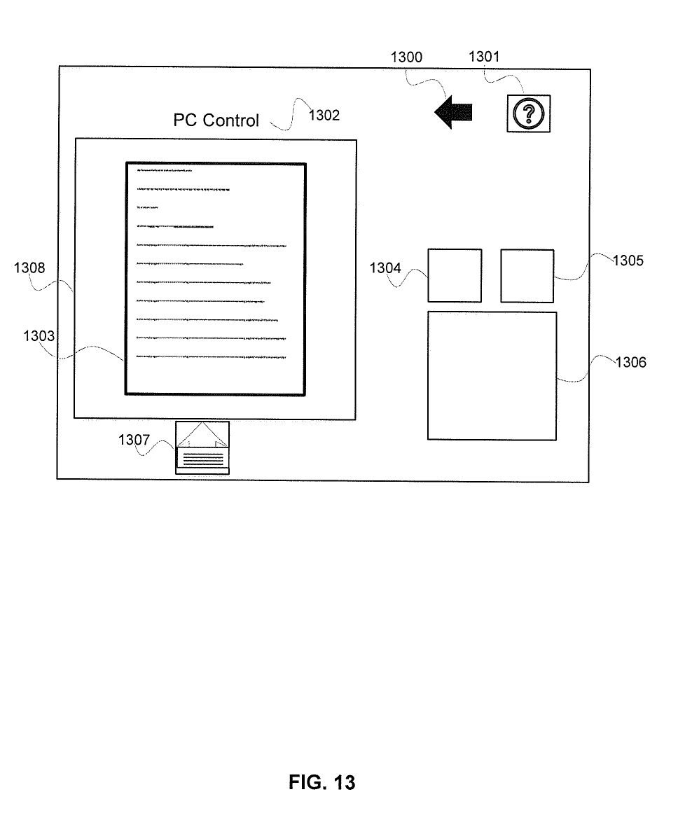

FIG. 3 illustrates control screen on interaction apparatus 200. In FIG. 3, control screen may show power on/off button 301, may show an area that represents or if capable show contents of display device on the left 302, if additional devices are available, may show an area that represents or if capable show contents of display device on the right 303, and may show additional area that represents or if capable show contents of display device for each additional device, a button may be shown which may swap contents of one display device for each additional device 304, if two screens are available button may be shown with function of swapping screen contents and if more than two screens are available one or more buttons may be shown which may activate a mechanism where user may choose two screens out of many and they may be swapped, or each button may have a predetermined screen which may be swapped, a button may be shown which may enable temperature control 305 for adjusting the temperature of room 100, a button may be shown which may enable light control 306 for adjusting the lighting in room 100, a button may be shown representing people on video conference 307, button may be shown representing content shared in video conference locally or coming from called party 308, one or more buttons may be shown for each PC/PC Laptop/Mac connected to system so they may be chosen for actions 309, one or more buttons may be shown for each document camera connected to system so they may be chosen for actions 310, one or more buttons may be shown for TV/satellite/cable/IPTV receiver or something else connected to system so they may be chosen for actions 311, one or more buttons may be shown for DVD receiver or something else connected to system so they may be chosen for actions 312, one or more buttons may be shown for video cameras connected to system so they may be chosen for actions 313, a call button may be shown which may enable screen for starting a call or add calls to existing call 314, a hang up button may be shown which may enable screen for hanging up existing calls individually or hang up all active a settings button may be shown which may change settings of the system calls 315, a settings button may be shown which may change settings of the system 316, may have help or like meaning button 317. If call button that may be shown 314 may be pressed and system may be not in a call at the moment, user may be presented with a first call screen as shown in FIG. 4. If call button that may be shown 314 may be pressed and system may be in a call at the moment, user may be presented with an additional call screen as shown in FIG. 5. If hang up button that may be shown 315 may be pressed and system may be in a call at the moment, user may be presented with a hang up screen as shown in FIG. 6. If camera button that may be shown 313 may be pressed, and video from camera cannot be shown on control screen user may be presented with a camera control screen as shown in FIG. 7. If camera button that may be shown 313 may be pressed, and video from camera may be shown on control screen user may be presented with a camera control screen as shown in FIG. 8. If document camera button that may be shown 310 may be pressed, and video from camera cannot be shown on control screen user may be presented with a camera control screen as shown in FIG. 9. if document camera button that may be shown 310 may be pressed, and video from camera may be shown on control screen user may be presented with a camera control screen shown in FIG. 10. If TV Control button that may be shown 311 may be pressed, a TV Control screen may be displayed as shown in FIG. 11. If DVD Control button that may be shown 312 may be pressed, a DVD Control screen may be displayed as shown in FIG. 12. If PC/PC Laptop/Mac Control button that may be shown 309 may be pressed, a PC/PC Laptop/Mac Control screen may be displayed as shown in FIG. 13.

FIG. 4 illustrates a first call screen on interaction apparatus 200 when call button may be pushed. In FIG. 4, there may be a redial button 401 which may display the last called video endpoint name or address 402, and may redial last called endpoint if that button may be pressed. A help or like meaning button may be shown 403 for user to get explanation and guidance to use the system, a favorites area may be shown 404, which may be populated by names and/or addresses users favorite endpoints 405, a scroll up button may be shown which may scroll favorites list up 406 and a scroll down button may be shown which may scroll favorites list down 407, a show last called list button may be shown 408 which may show a screen with names/addresses of last places called so they may be called again, an add new entry button may be shown 409 which may add new entries to favorites and/or address book, and search address book button may be shown 410 which may search address book and dial using address book, a button may be shown which may change settings 411.

FIG. 5 illustrates screen on interaction apparatus 200 for second and further calls to be added to existing call or calls when call button may be pushed. Screen may have a message with a meaning similar to currently in call 501 and currently in call area 502 which may display the video endpoint names or addresses in call 504, and may redial last called endpoint if that button may be pressed. A help or like meaning button may be shown 503 so user may get explanation and guidance to use the system, a favorites area may be shown 505, which may be populated by names and/or addresses users favorite endpoints 506, a scroll up button may be shown which may scroll favorites list up 507 and a scroll down button may be shown which may scroll favorites list down 508, a show last called list or like meaning button may be shown 509 which may show a screen with names/addresses of last places called so they may be called again, an add new entry button or like meaning may be shown 510 which may add new entries to favorites and/or address book, and an address book or like meaning button may be shown 511 which may search address book and dial using address book, a button may be shown which may change settings 512.

FIG. 6 illustrates call hang-up screen on interaction apparatus 200 when hang-up button may be pushed. Screen may have a message with a meaning similar to currently in call 603 and screen may have currently in call area 602 which displays the video endpoint names or addresses in call 604, and hang up buttons may be shown related to entries 608 may hang up connection related to that entry if user may press it, a help or like meaning button may be shown 601 so user may get explanation and guidance to use the system, a scroll up button maybe shown which may scroll in call end point list up 606 and a scroll down button may be shown which may scroll in call end point list down 607, a hang up all button may be shown 609 which may hang up all calls in progress, a button may be shown which may change settings 610.

FIG. 7 illustrates camera control screen without image/video display on interaction apparatus 200. Screen may have a message with a meaning similar to currently in call and currently in call area may be shown 703 which may display the video endpoint names or addresses in call, a call button may be shown 701 which may make a call, a hang up button may be shown 702 which may hang up connection, a help or like meaning button may be shown 709 for user which may get explanation and guidance to use the system, one button may be shown per display available, or a two display system a left display button may be shown 704, and right display button may be shown 705, one or more camera button may be shown designating each camera available 706, one or more PC/PC Laptop/Mac buttons may be shown designating each PC/PC Laptop/Mac connected to system 707, one or more document camera buttons may be shown designating each document camera connected to system 708, a touch or button based camera control area 700, and a power button may be shown 711 which may power system off.

FIG. 8 illustrates camera control screen with image/video display on interaction apparatus 200. Screen may have a message with a meaning similar to currently in call and currently in call area 803 which displays the video endpoint names or addresses in call, a call button may be shown 801 which may make a call, a hang up button may be shown 802 which may hang up connection, a help or like meaning button may be shown 809 for user which may get explanation and guidance to use the system, one button may be shown per display available, or a two display system a left display button may be shown 804, and right display button may be shown 805, one or more camera button may be shown designating each camera available 806, one or more PC/PC Laptop/Mac buttons may be shown designating each PC/PC Laptop/Mac connected to system 807, one or more document camera buttons may be shown designating each document camera connected to system 808, help or like meaning button may be shown 809 for user which may get explanation and guidance to use the system, a touch or button based camera control area overlaid with video coming from camera may be shown 800, and a power button may be shown 811 which may power system off.

FIG. 9 illustrates document camera screen without image/video display on interaction apparatus 200. Screen may have an area which may control storing displayed picture in memory 903 which allows choosing a memory slot and storing and recalling images, a light button may be shown 901 which may turn camera light on and off, if a light may be available on camera, a power button may be shown 902 which may turn document camera on and off, a help or like meaning button may be shown 908 for user which may get explanation and guidance to use the system, an area with camera view angle presets 904 which may show different view angles for common used sizes of view, a freeze image button may be shown 905, and a live image button may be shown 906, a touch or button based camera control area may be shown 900.

FIG. 10 illustrates document camera screen with image/video display on interaction apparatus 200. Screen may have an area which may control storing displayed picture in memory 1003 which allows choosing a memory slot and storing and recalling images, a light button may be shown 1001 which may turn camera light on and off, if a light may be available on camera, a power button may be shown 1002 which may turn document camera on and off, a help or like meaning button may be shown 1008 for user which may get explanation and guidance to use the system, an area with camera view angle presets 1004 which may show different view angles for common used sizes of view, a freeze image button may be shown 1005, and a live image button may be shown 1006, a touch or button may be shown based camera control area 1000 overlaid with video coming from camera 1007.

FIG. 11 illustrates TV control screen on interaction apparatus 200. which may have a back button 1100 which may go back to previous screen, a help or like meaning button may be shown 1101 for user which may get explanation and guidance to use the system, a text meaning similar to TV control 1102, a display area for TV video 1103 if displaying video may be possible on screen, a favorites area 1104 with each favorite channel may be represented with a button may be shown 1105, and a button may be shown which may scroll the favorites area backward 1106 and forward 1107, a all channel area 1108 with each favorite channel may be represented with a button may be shown 1109, and a button may be shown which may scroll the favorites area backward 1110 and forward 1111, a settings button may be shown 1112 which may change settings.

FIG. 12 illustrates CD/DVD/Blue-ray control screen on interaction apparatus 200. which may have a back button 1200 which may go back to previous screen, a help or like meaning button may be shown 1201 for user to get explanation and guidance to use the system, a text meaning similar to DVD control 1202, a display area for DVD video 1203 if displaying video may be possible on screen, a transport control area 1204 with commands to control DVD may be represented with button fields, and a button may be shown which may scroll the button area backward 1205 and forward 1206, a settings button may be shown 1207 which may change settings.

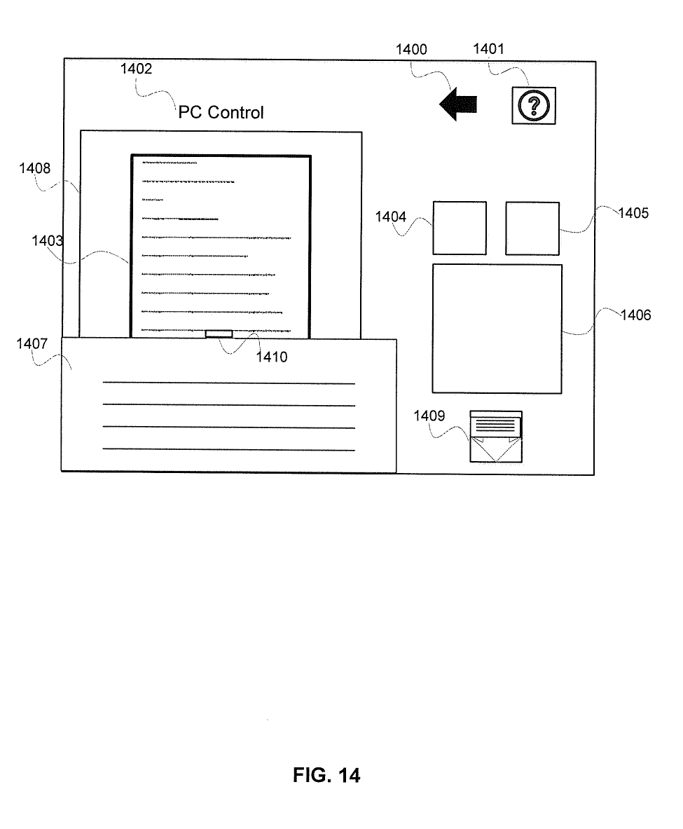

FIG. 13 illustrates PC/PC Laptop/Mac control when virtual keyboard is hidden screen on interaction apparatus 200 which may have a back button 1300 which may go back to previous screen, a help or like meaning button may be shown 1301 for user which may get explanation and guidance to use the system, a text meaning similar to PC/PC Laptop/Mac control 1302, a display area for PC/PC Laptop/Mac image 1308 if displaying video may be possible on screen, a mouse left click button may be shown 1304, a mouse right click button may be shown 1305, a virtual touchpad may be shown 1306, a keyboard show hide button may be shown 1307. If displaying image from PC/PC Laptop/Mac on the screen may be possible, tapping, double tapping, dragging on the image may have similar effect of clicking, double clicking, dragging with mouse at the tapped, double clicked, dragged points. if keyboard show hide button that may be shown may be pressed 1307, a virtual keyboard may be shown on the screen as shown in FIG. 14.

FIG. 14 illustrates PC/PC Laptop/Mac control when virtual keyboard is visible and operational screen on interaction apparatus 200. There may be a back button 1400 which may go back to previous screen, a help or like meaning button may be shown 1401 for user which may get explanation and guidance to use the system, a text meaning similar to PC/PC Laptop/Mac control 1402, a display area for PC/PC Laptop/Mac image 1408 if displaying video may be possible on screen, a mouse left click button may be shown 1404, a mouse right click button may be shown 1405, a virtual touchpad may be shown 1406, a virtual keyboard may be shown 1407 which may be moved around by dragging the move bar 1410, while keeping all the functions of buttons may be shown on screen operational if they are not covered by virtual keyboard. Virtual keyboard may be closed by pushing virtual keyboard close button 1409.

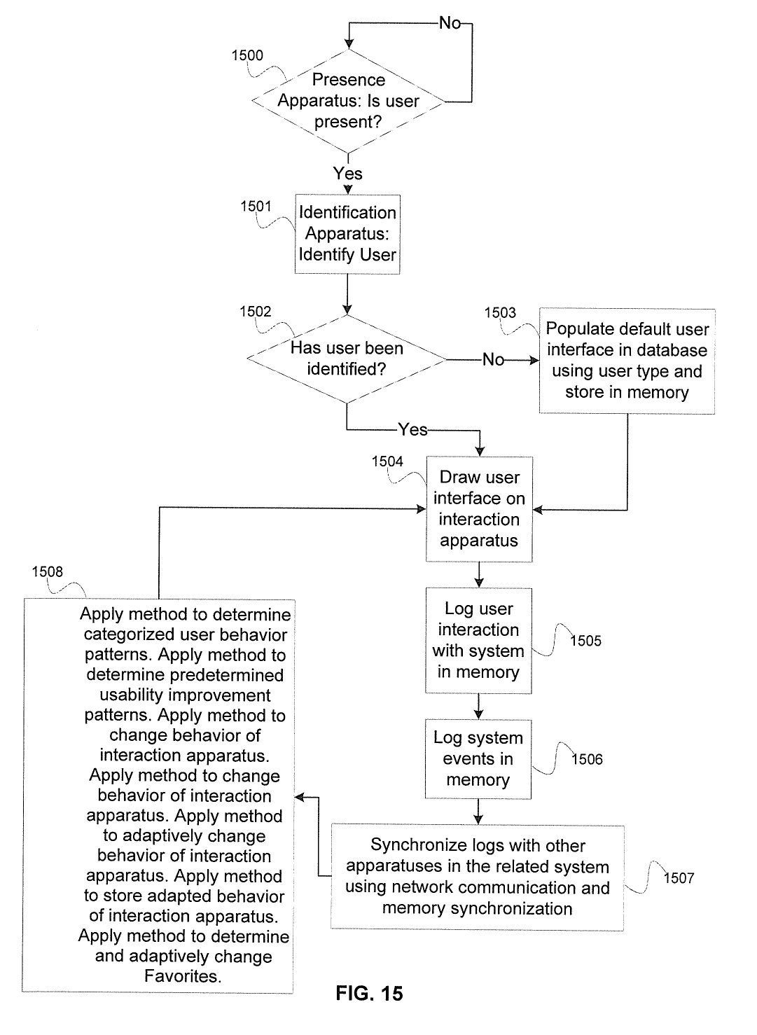

FIG. 15 illustrates a flowchart of the procedure for detecting presence of people and identifying user or users. Presence apparatus constantly queries sensors to find out whether user is present, if there is no user presence, apparatus continues to check for user presence 1500. Once user presence is detected, identification apparatus identifies the user 1501, if identification is successful, user interface for that user is fetched from database, if there is no user interface for the user is defined then a default user interface is populated in the database and memory for that user type 1503. Once user interface for that particular user is fetched, it is drawn on interaction apparatus 1504. Once user interface is displayed, interaction apparatus or controlling apparatus logs user interaction with system in the memory 1505 and also logs system events in memory 1506, and logs are synchronized bidirectional with other apparatuses and controlling apparatus 1507, once logs are synchronized, methods to determine changes are applied and new user interface is determined and stored in database for that user and user interface is communicated to interaction apparatuses in the system 1508 and user interface is redrawn 1504

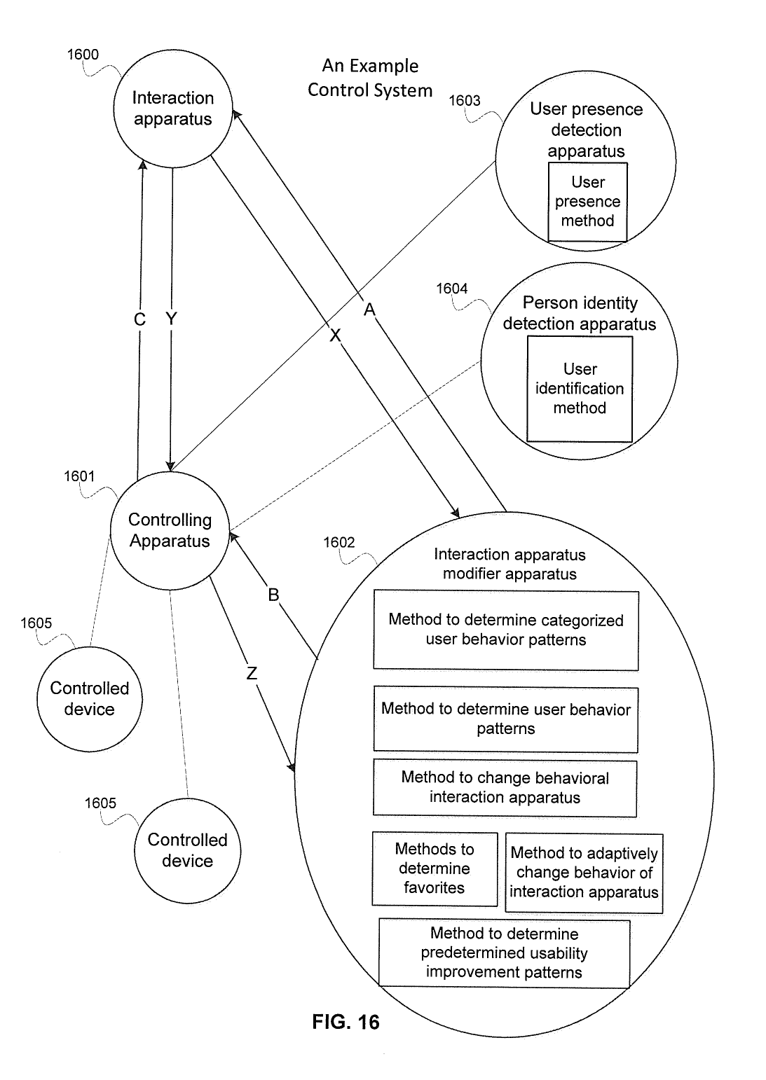

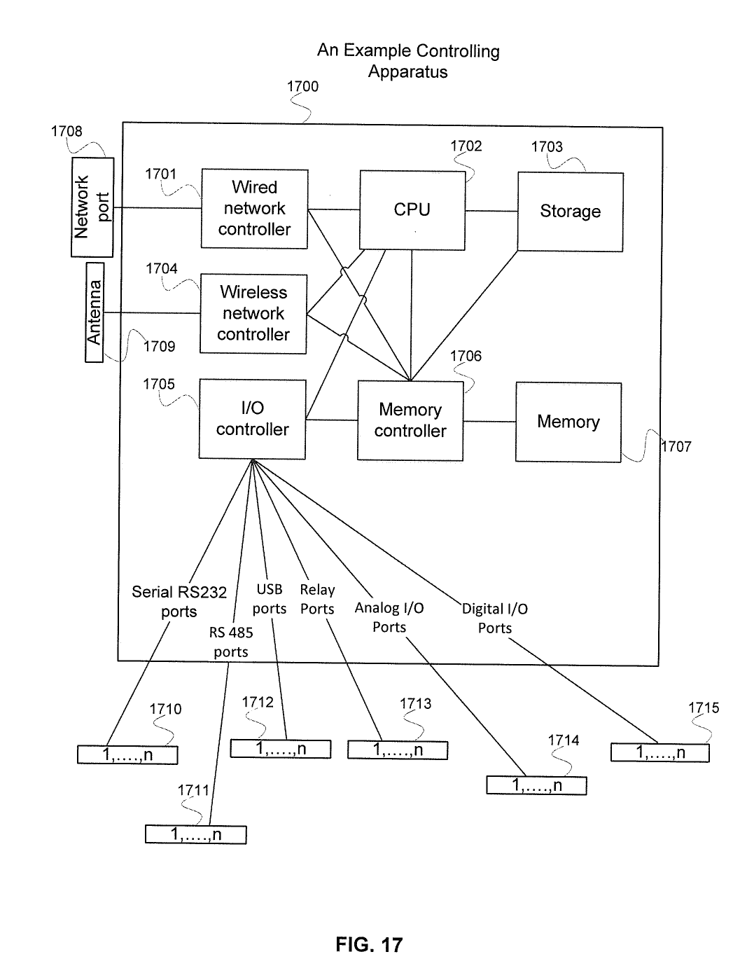

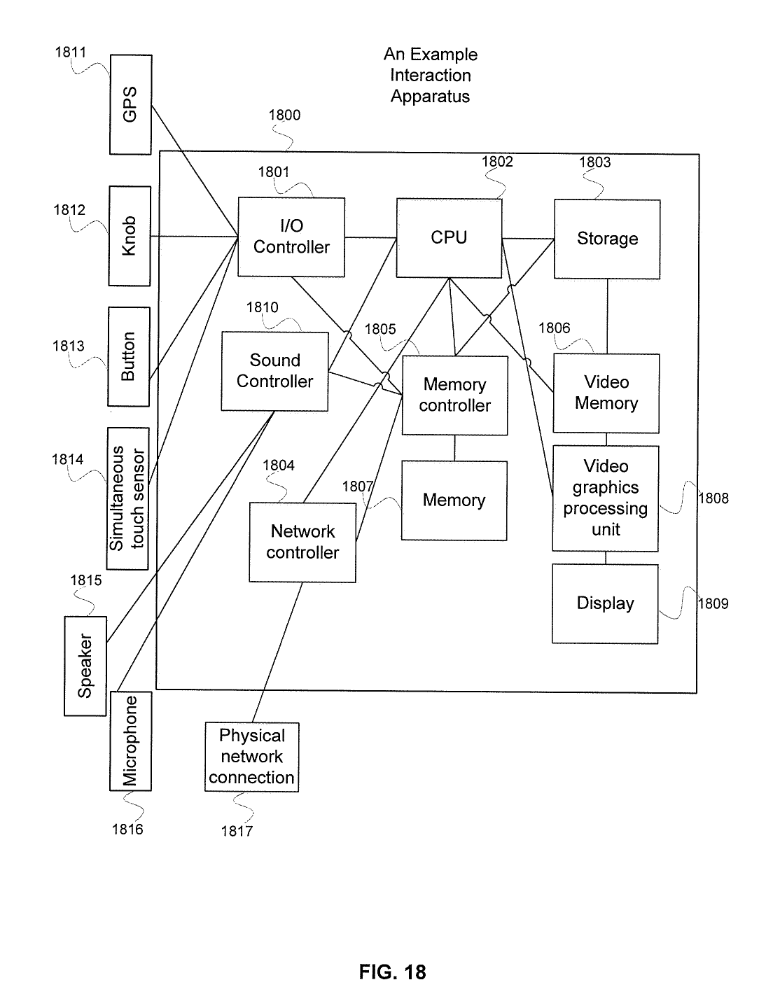

FIG. 16 illustrates an example control system. Control system may include singularity or plurality of the components of controlling apparatuses 1601, interaction apparatuses 1600, presence detection apparatuses 1603, person identity detection apparatuses 1604, interaction apparatus modifier apparatuses 1602, other apparatuses and may include none or one or more methods described in this document or any other methods necessary for the functioning of such system
FIG. 17 illustrates an example controlling apparatus. Controlling apparatus 1700 may be used to receive user input from interaction apparatus over one or more of wired network ports 1708, wireless network ports 1704, RS232 ports 1710, RS422 ports 1711 or any other type of ports which may facilitate communication between controlling apparatus and interaction apparatus. Controlling apparatus may be used to send output and user interface to interaction apparatus, send and receive commands to and from systems and devices that has means to be controlled using RS232 1710, RS422 1711, USB 1712, Relay 1713, Analog I/O 1714, Digital I/O 1715 ports or any other type of ports that may facilitate communication between controlling apparatus and devices that has means to be controlled. Controlling apparatus has a central processing unit (CPU) 1702 to process programs and data, a storage to store program and data 1703, a memory controller to facilitate memory transfers 1706, memory for runtime which may be RAM or flash 1707, wired network controller 1701, wireless network controller 1704, Input/Output (I/O) controller 1705 and a wired network port 1708 and a wireless network antenna 1709.
FIG. 18 illustrates an example interaction apparatus. An interaction apparatus 1800 such as touch screen based devices may be used to interact with the user of such adaptive system

Interaction apparatus may be comprised of one or more of the following: 1) Button 1813, knobs 1812, sliders and similar means of physical control means, 2) Means to display 1809 visual user interface and give visual feedback, 3) Means to generate sounds using a sound controller 1810 and speaker 1815, 4) Means to receive touch input on display 1814, 5) Means to receive voice or sound input using microphone 1816 or other means of inputting voice or sound, 6) Means to determine the location of interaction apparatus using GPS 1811, triangulation or any other location detection technology.

Interaction apparatus may have singularity or plurality of the following components in visual user interface: Layouts, graphics, icons, text, animations.

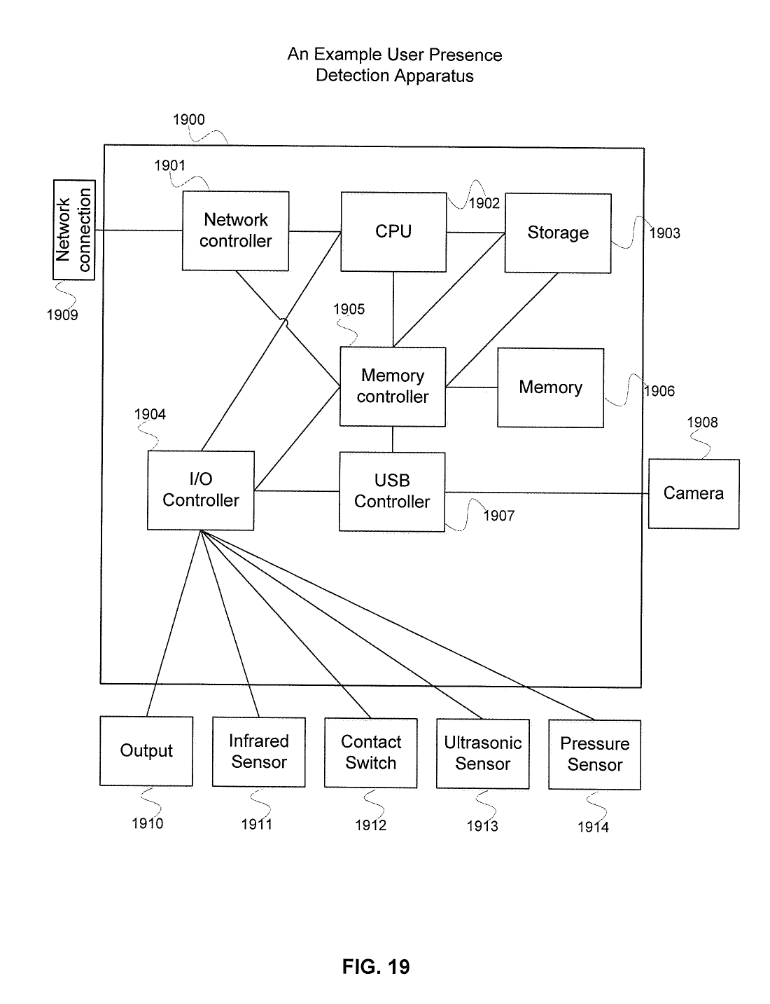

FIG. 19 illustrates an example user presence detection apparatus. A presence detection apparatus 1900 such us presence detection devices may be used to detect that someone is present in the vicinity of the controllable system or interaction apparatus or any other related place.

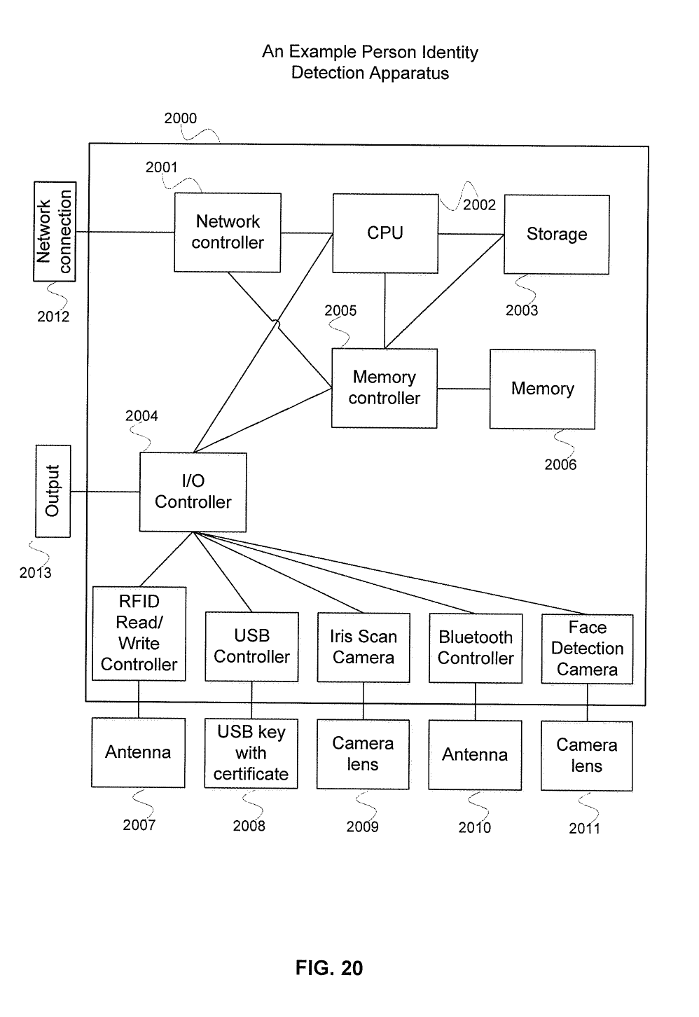

User presence may be detected with one or more of the following: 1) Ultrasonic motion detectors 1913, 2) Cameras 1908, 3) Infrared sensors, 1911 4) Pressure sensors 1914 (if a person steps on an area), 5) Contact switches 1912 (open door, close door etc), 6) Other ways of detecting a person in the vicinity of controlling apparatus and or interaction apparatus.
User Presence Detection apparatus has a central processing unit (CPU) 1902 to process programs and data, a storage to store program and data 1903, a memory controller to facilitate memory transfers 1905, memory for runtime which may be RAM or flash memory 1906, wired network controller 1901, Input/Output (I/O) controller 1904 and a wired network port 1909.
   FIG. 20 illustrates an example person identity detection apparatus. A person identity detection apparatus 2000 such as identification devices may be used to identify the user. Identification may be none or more of the following: identifying unique user, or identify the department, group, organization, company or authority level of the user. Identification type is not limited to options mentioned and may include any types of identification that allows system to adapt itself for that type of identification.

Identification may be done by none or more of the following technologies: any type of RFID tag 2007, any type of proximity tag, any type of smartcard, any type of identification device, any type of USB device 2008, any type of fingerprint reader device, any type of iris scan device 2009, Bluetooth device MAC id or device ID 2010, unique username, password and pin number, any type of face detection device 2011, any type of device which has means of communicating identification information to reader.

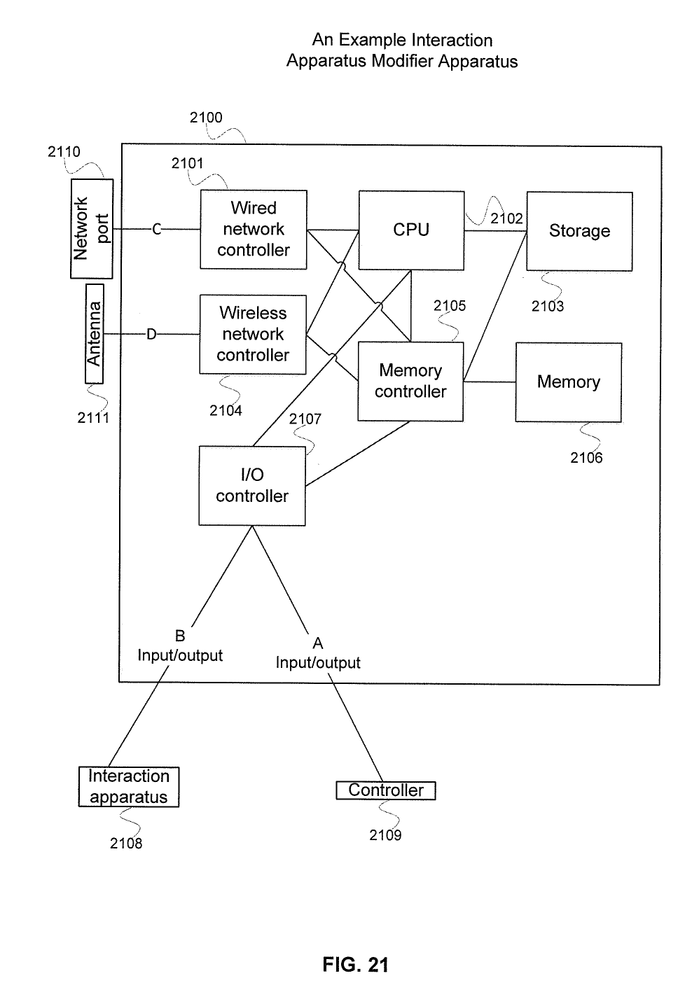

Person Identity Detection apparatus has a central processing unit (CPU) 2002 to process programs and data, a storage to store program and data 2003, a memory controller to facilitate memory transfers 2005, memory for runtime which may be RAM or flash memory 2006, wired network controller 2001, Input/Output (I/O) controller 2004 and a wired network port 2012.
FIG. 21 illustrates an interaction apparatus modifier apparatus. An interaction apparatus modifier apparatus may determine the initial setting and as users use the control system, it may determine adaptive changes that will occur in the interaction apparatus such as changes in user interface and actions of user interface elements on a touch based screen.

Interaction apparatus modifier apparatus 2100 may gather one or more of the following information: User interface elements used, frequency of elements being used, type of users who use certain elements, which interaction apparatus is being used, which control system is being used, other information that may be relevant to detect user behavior patterns.

Interaction apparatus modifier apparatus may gather the information from the singularity or plurality of the following sources: interaction apparatus 2108, controlling apparatus 2109, presence detection apparatus, person identity detection apparatus, user presence method, user identification method, method to determine behavior patterns, method to determine categorized user behavior patterns, method to determine predetermined usability improvement patterns, method to change behavior of interaction apparatus, method to adaptively change behavior of interaction apparatus, method to store adapted behavior of interaction apparatus, method to determine favorites, control system, controlled device.

Interaction apparatus modifier apparatus may use one or more of the following methods to determine type of change in the interaction apparatus:. Method to determine behavior patterns, method to determine categorized user behavior patterns, method to determine predetermined usability improvement patterns, method to change behavior of interaction apparatus, method to adaptively change behavior of interaction apparatus

Interaction apparatus modifier apparatus may use Method to store adapted behavior of interaction apparatus to store the changes in the interaction apparatus:

Interaction apparatus modifier apparatus could be a standalone apparatus, or part of controlling apparatus, interaction apparatus, control system, controlled device.

Interaction apparatus modifier apparatus has a central processing unit (CPU) 2102 to process programs and data, a storage to store program and data 2103, a memory controller to facilitate memory transfers 2105, memory for runtime which may be RAM or flash memory 2106, wired network controller 2101, Input/Output (I/O) controller 2107 and a wired network port 2110, wireless network controller 2104, wireless antenna for wireless network controller 2111.
User presence method is described in detail as follows:

User presence method defines the process to detect user presence in an effective manner. It may include one or more of the following: Using one or more detection hardware to eliminate false positives of user presence, using fuzzy logic to increase ability to detect presence properly, using preset logic to detect presence at certain times, using logic to identify the presence of human objects as positive presence identification and objects that are not human as negative presence identification, using logic to identify presence fast enough so the control system has time to identify the user and present with the customized user interface.

User identification method is described in detail as follows:

User identification method defines the process to identifying unique user, or identify the department, group, organization, company or authority level of the user.

Method aims to achieve higher accuracy on identifying.

To achieve higher accuracy, method may use one or more of the following mechanisms: Certificates from certificate authorities, unique identification numbers, usernames which could be one or more characters including but not limited to alphabet letters in any language, numeric digits, symbols and any other identifying character or similar means to achieve uniqueness of username, personal identification number or personal identification code which could be one or more characters including but non limited to alphabet letters in any language, numeric digits, symbols and any other identifying character or similar means to achieve uniqueness of personal identification code or personal identification number, three way handshake authentication, shared key authentication, kerberos authentication, any other authentication method that may be available for use.

Method to determine behavior patterns is described in detail as follows:

Method to determine behavior patterns defines the process to determine behavior patterns of unique user, department, group, organization, company or authority level and other classification types that may improve the dynamic user interface usability.

Method to determine behavior patterns may use one or more of the following data: Type of user, type of action, control system, controlling apparatus, interaction apparatus user used.

Method to determine behavior patterns observes the following patterns to classify patterns as such: Frequency of action, statistical distribution type of action, demographic distribution type of action, response time of user, frequently used areas on the user interface.

Method to determine categorized user behavior patterns is described in detail as follows:

Method to determine categorized user behavior patterns defines the process to compare behavior patterns of unique user, department, group, organization, company or authority level and other classification types to behavior patterns of other unique user, department, group, organization, company or authority level and other classification types.

Method to determine behavior patterns may use one or more of the following data: Type of user, type of action, control system, controlling apparatus, interaction apparatus user used

Method to determine categorized user behavior patterns compares patterns to each other for the following criteria: Frequency of action, statistical distribution type of action, demographic distribution type of action, response time of user, frequently used areas on the user interface.

Method to determine categorized user behavior patterns deducts one or more the following patterns: 1) For each classification determine percentile of user behavior in related to other user, department, group, organization, company or authority level and other classification types 2) Determine Success rate of actions to achieve certain goal on using the system (for example dialing a video conference) by peer user, department, group, organization, company or authority level and other classification types. 3) Determine the user interface elements, location, layout and other user interface characteristics that leads to successful completion of certain goals 4) Categorize user actions which may achieve the goals 5) Determine which group pattern a certain user, department, group, organization, company or authority level and other classification types approximates

Method to determine predetermined usability improvement patterns inherent to design of system is described in detail as follows:

Method to determine predetermined usability improvement patterns inherent to design of system defines the process to compare behavior patterns of unique user, department, group, organization, company or authority level and other classification types to predetermined usability improvement patterns define in the design of system.

Method to determine predetermined usability improvement patterns inherent to design of system may use one or more of the following data: type of user, type of action, control system, controlling apparatus, interaction apparatus user used

Method to determine predetermined usability improvement patterns inherent to design of system compares patterns to each other for the following criteria: Frequency of action, statistical distribution type of action, demographic distribution type of action, response time of user, frequently used areas on the user interface.

Method to determine predetermined usability improvement patterns inherent to design of system deducts the following patterns: For each classification determine percentile of user behavior in relation to patterns defined in the system design, determine which group pattern a certain user, department, group, organization, company or authority level and other classification types approximates.

Method to change behavior of interaction apparatus is described in detail as follows:

Method to change behavior of interaction apparatus defines the process to change the behavior of interaction apparatus and may include the following: Identify the user by identifying using department, group, organization, company or authority level and other classification types approximation, if user does not have any user interface defined for the user, determine a default user interface based on user interface used by user's department, group, organization, company or authority level and other classification types approximation, method to adaptively change behavior of interaction apparatus.

Method to change behavior of interaction apparatus defines the process to change the behavior of interaction apparatus and may include the following: Using method to determine behavior patterns, method to determine categorized user behavior patterns, method to determine predetermined usability improvement patterns inherent to design of system, determine the elements of user interface that needs adjustment, change or deletion, determine the behavior of such elements and transmit that information to Interaction apparatus modifier apparatus.

Method to store adapted behavior of interaction apparatus is described in detail as follows:

Method to store adapted behavior of interaction apparatus defines methods to store the behavior of interaction apparatus and may include one or more of the following: 1) For each user, provide means to store the user interface, and classification information by adaptive behavior, in some form of database structure, database management system, file or any other type of information storage method, which may be stored in hard drive, RAM, flash drive, solid state hard drive, RFID memory, memory of user identification devices, other methods of central or proximity read write storage, or any other means of storage which may be located in interaction apparatus, interaction apparatus modification apparatus, controller apparatus, local servers, remote servers or any approriate location to store such data. 2) For each user, provide means to fetch the user interface, and classification information by adaptive behavior, from some form of database structure, database management system, file or any other type of information storage method, which may be stored in hard drive, RAM, flash drive, SD drive or any other means of storage which may be located in interaction apparatus, interaction apparatus modification apparatus, controller apparatus, local servers, remote servers or any appropriate location to store such data

### Favorites

Favorites are elements of user interface that may be defined by user, defined by system administrator, or deducted by using method to determine behavior patterns, method to determine categorized user behavior patterns, method to determine predetermined usability improvement patterns inherent to design of system. Once determined, the elements of user interface that needs adjustment, change or deletion, would be transmited to interaction apparatus modifier apparatus.

### Controlled Device

Controlled device may include being a device which may be controlled by none or one or more of controlling apparatuses or interaction apparatuses or other apparatuses described above or any other apparatus.

I claim:

1. A method, comprising:
a presence apparatus querying sensors to determine whether a user is present;
an identification apparatus identifying the user responsive to a determination that the user is present;
an interaction apparatus displaying a user interface responsive to the identifying;
the interaction apparatus logging user interaction with the user interface;
the interaction apparatus synchronizing the logged user interaction with a controlling apparatus; and
the controlling apparatus performing at least one user behavior method responsive to the synchronizing.
